(19) United States
(12) Patent Application Publication
(10) Pub. No.: US 2024/0390801 A1
(43) Pub. Date: Nov. 28, 2024

(54) Systems and Methods for Mod-Supporting Authoritative Game Server

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/670,011

(22) Filed: May 21, 2024

Related U.S. Application Data
(60) Provisional application No. 63/503,627, filed on May 22, 2023.

(51) Int. Cl. A63F 13/77; A63F 13/69

(52) U.S. Cl. CPC A63F 13/77; A63F 13/69

(57) ABSTRACT

Systems and methods for implementing an authoritative universal game server configured to support game modifications are disclosed herein. A game server may include at least a simulator configured to modify a simulator and published state based on input received or as a result of time passing, and one or more nodes each comprising a sandbox responsible for running third-party code within the game server. The third-party code run on the game server may include both base assets corresponding to a version of an online game provided by a publisher of the online game and overridden assets that comprise base assets that have been modified by a user. Thus, the game server may be configured to run a modified version of the online game when using overridden assets. Systems and methods for improving performance of server-side simulations by skipping simulation ticks or abolishing simulation ticks entirely are also described herein.

### RELATED APPLICATIONS

This application claims priority to U.S. Provisional Application No. 63/503,627, entitled “Method for Mod-Supporting Authoritative Game Server,” filed on May 22, 2023, the content of which is hereby incorporated herein by reference in its entirety.

### FIELD OF THE DISCLOSURE

The systems and methods described herein relate to an authoritative game server configured to support game modifications.

### BACKGROUND

In three-dimensional online games, various game assets are frequently used to express computer-generated graphics or three-dimensional models. Game assets include different three-dimensional objects such as characters, items, cars, furniture, buildings, or other structures. Most of the time, game assets are incorporated into the three-dimensional online games and are downloaded when players decide to purchase games. As the complexity and detail of game assets in online games increases (for example, to accommodate the use of augmented or virtual reality), maintaining an adequate download and loading-to-screen time becomes increasingly difficult. Indeed, as the size of the game assets increases, so too does transmission data size, transmission time, memory usage, and rendering time.

Game modding (short for “modification” or “modifying”) is a hobby for many people. Game modding is a process of alteration by players or fans of a game in which the players or fans may modify aspects of the online game to affect how it looks or plays. Mods may differ from small changes and tweaks to complete overhauls and, in some instances, may greatly extend the replay value and interest of a game. Mods have become an increasingly important factor in the commercial success of some games, as they add depth to the original work, and can be both fun for players playing the mods and as a means of self-expression for mod developers. However, more often than not, game modding may not be supported by game creators, particularly in the case of server-side-driven authoritative game servers. In light of the foregoing, improved systems or techniques that enable authoritative game servers to support game modifications would represent an improvement over existing systems.

### SUMMARY OF THE DISCLOSURE

This disclosure relates to systems and methods for implementing an authoritative universal game server configured to support game modifications. According to one aspect of the invention, a game server described herein is configured to provide updates related to an online game. In various implementations, the game server may be configured to sandbox potentially malicious event-driven code. In various implementations, the game server may include at least a simulator configured to modify a simulator state and a published state based on input received or as a result of time passing, and one or more nodes each comprising a sandbox responsible for running third-party code within the game server. In various implementations, the third-party code is event-driven in that it may only receive and react to events. In various implementations, the third party-code may only be able to manipulate an external state via an application programming interface (API). In some implementations, any one sandbox may be configured to run multiples pieces of third-party code with a next piece of code running after a previous piece of code is completed. In such implementations, each of the multiple pieces of third-party code may be configured to use a different external state. In some implementations, the third-party code is run by a programming language engine. For example, the programming language engine may comprise a WebAssembly (Wasm) engine or an interpreter or Just-in-time (JIT) compiler of a programming language. In some implementations, the programming language engine may comprise an interpreter or Just-in-time (JIT) compiler of a programming language that is run within a virtual machine or other container. In some such implementations, the virtual machine or other container may include an intrusion detector configured to detect unusual activity within the virtual machine or other container. In response to detecting unusual activity, the intrusion detector may be configured to take corrective action. For example, the corrective action may comprise terminating the virtual machine or other container. In some implementations, to support game modifications, the third-party code run on the game server may include both base assets corresponding to a version of an online game provided by a publisher of the online game and overridden assets that comprise base assets that have been modified by a user. In such implementations, the game server may be configured to run a modified version of the online game when running using one or more overridden assets.

According to another aspect of the invention, systems and methods for improving performance of server-side simulations by skipping simulation ticks are described herein. In various implementations, a game server may be configured to provide to one or more client computer systems game state data related to a first time corresponding to a simulation tick. The game state data may include information necessary for client computer system to predict a simulation at subsequent points in time unless input is received. The game server may be configured to determine that the simulation can be predicted by the one or more client computer systems at a point in time corresponding to at least one subsequent simulation tick based on the previously provided game state data related to the first time. In various implementations, determining that the simulation can be predicted by a client computer system may include running the simulation in advance for one or more subsequent points in time (i.e., a “pre-simulation”) based on the game state data related to the first time and comparing publication results for the one or more subsequent points in time to the pre-simulation run based on the game state data related to the first time. In such implementations, simulation ticks may be skipped as long as publication results are the same as the pre-simulation run based on the game state data related to the first time. Indeed, responsive to a determination that the simulation can be predicted by the one or more client computer systems, the game server may be configured to skip one or more simulation ticks.

According to another aspect of the invention, systems and methods for improving performance of server-side simulations by abolishing simulation ticks entirely are described herein. In various implementations, a game server may be configured to provide to one or more client computer systems game state data related to a first time. The game state data may include information necessary for client computer system to predict a simulation at subsequent points in time unless input is received. The game server may be configured to calculate a next point in time at which the one or more client computer systems may not predict a simulation based on the game state data related to the first time. In various implementations, the game server may be configured to determine a next timer event for simulation based on the calculated point in time at which the one or more client computer systems may not predict a simulation based on the game state data related to the first time. In various implementations, the next timer event may correspond to a next time at which an update to a simulation is to occur. In some implementations, determining the next timer event may comprise calculating a duration of time with no interactions between objects. In some implementations, determining the next timer event may comprise calculating a duration of time with no unpredictable interactions between objects. For example, an unpredictable interaction between objects may comprise a collision between moving objects.

According to another aspect of the invention, systems and methods for simulating character reflexes in online games are described herein. In various implementations, a player proxy on a game server may be configured to receive player input. The player proxy may be configured to augment the player input based on updated game state data. In various implementations, augmenting the player input may comprise imitating character reflexes or conditioned reflexes. In some implementations, augmenting the player input may comprise taking an evasive action based on a decision regarding whether a collision is imminent. In some implementations, augmenting the player input may comprise adding visual information to augment reflexes. In some implementations, the visual information added to augment reflexes may be restricted to a player character's viewing frustum. The player proxy may be configured to provide the augmented player input to a simulator configured to run a simulation of a game world based at least in part on the augmented player input. In some implementations, similar operations may be performed by a non-player character (NPC) artificial intelligence (AI) node to augment said input for display on a non-player character.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to render computer-generated three-dimensional objects at a client computer system based on game state data provided by a game server, according to one or more aspects described herein;

FIG. 2 depicts a block diagram of an example universal game server configured to support game modifications, according to one or more aspects described herein; and

FIG. 3 depicts a flow diagram of an example of a method for improving performance of server-side simulations by skipping simulation ticks, according to one or more aspects described herein;

FIG. 4 depicts a flow diagram of an example of a method for improving performance of server-side simulations by abolishing simulation ticks entirely, according to one or more aspects described herein; and

FIG. 5 depicts a flow diagram of an example of a method for simulating character reflexes in online games, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

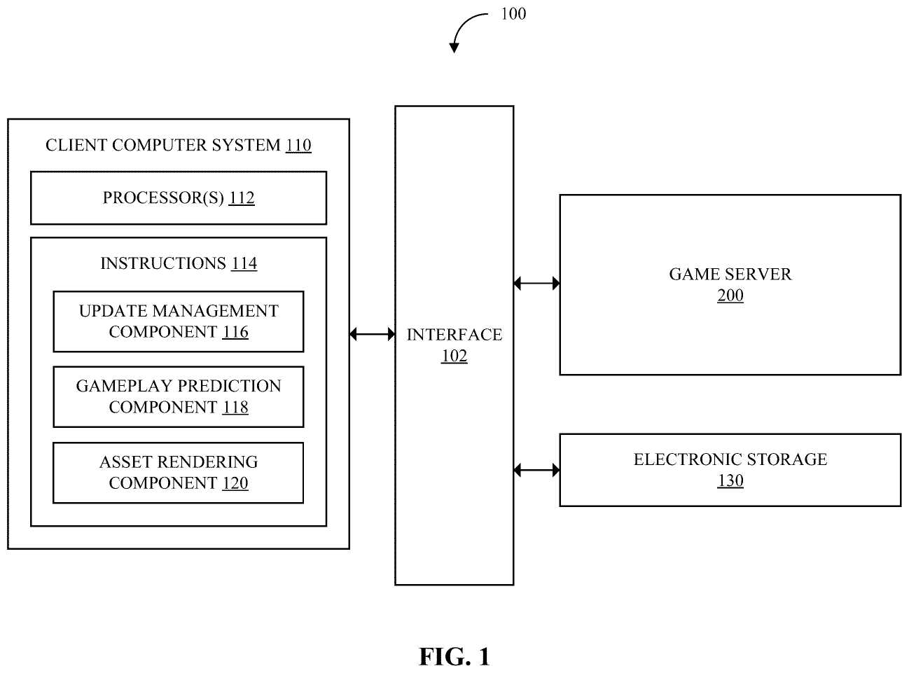

FIG. 1 depicts a block diagram of an example of a system 100 configured to render computer-generated three-dimensional objects at a client computer system 110 based on game state data provided by a game server 210, according to one or more aspects described herein. In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and game state data related to an online game comprising three-dimensional virtual scenes from game server 210. Notably, while “three-dimensional objects” and “three-dimensional virtual scenes” are referred to herein, the techniques described herein may apply equally to “two-dimensional objects” and “two-dimensional virtual scenes.” As such, all references herein to “three-dimensional objects” and “three-dimensional virtual scenes” may be replaced with “two-dimensional objects” and “two-dimensional virtual scenes,” respectively. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors (also interchangeably referred to herein as processor(s), processor, or processors for convenience), computer readable instructions, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

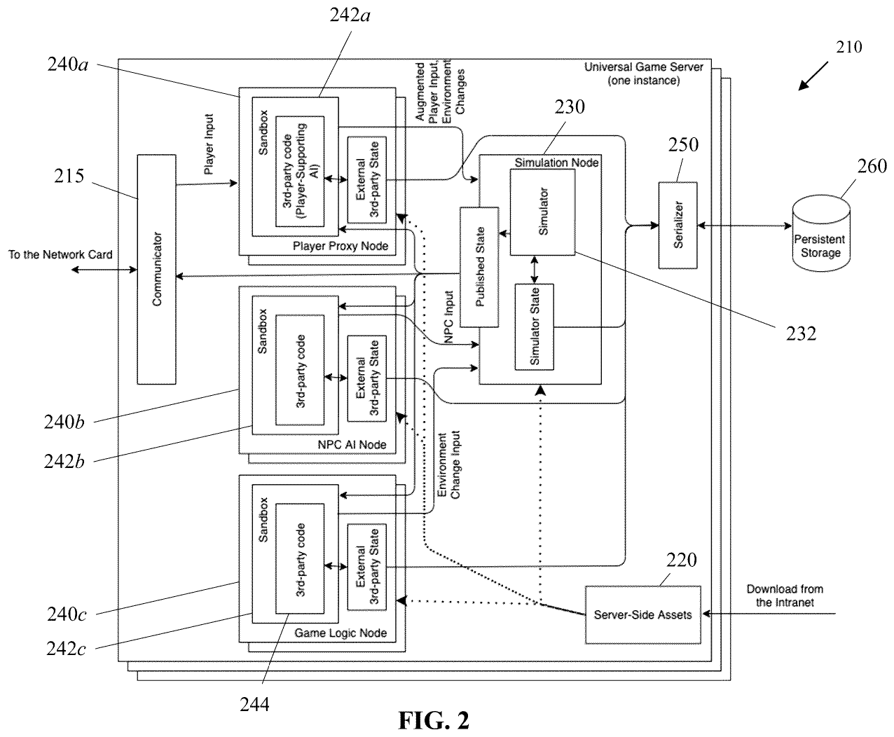

In various implementations, processor(s) 112 and one or more components of game server 210 may be configured to provide information processing capabilities in system 100. As such, in some implementations, the processor(s) 112 and/or game server 210 may comprise or include one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of download management component 116, gameplay prediction component 118, asset rendering component 120, and/or one or more other computer program components. As used herein, for convenience, the various computer readable instructions 114 will be described as performing an operation, when, in fact, the various instructions program the processor(s) 112 (and therefore client computer system 110) to perform the operation. In various implementations, game server 210 may be configured to execute one or more computer readable instructions. For example, the computer readable instruction may be configured to cause game server 210 to implement or facilitate some or all of the functionality of gamer server 210 described at least with respect to FIG. 2.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers”. In response to the updated game state data and/or as otherwise necessary, client computing system 110 may be configured to download game assets from game server 210 for rendering within virtual scenes of the game. To that end, in various implementations, game server 210 may be configured to generate, organize, encode, and/or otherwise manage game assets used to render a virtual scene. For example, game assets may comprise the three-dimensional objects that, when rendered, make up a virtual scene in a game.

In various implementations, update management component 116 may be configured to manage updates and other information received by client computer system 110 from game server 210. In various implementations, gameplay prediction component 118 may be configured to predict (or calculate) information (such as the coordinates or velocity) of an object based on information received from game server 210. In various implementations, asset rendering component 120 may be configured to render game assets within a virtual scene.

In various implementations, game server 210 may comprise a universal game server configured to support game modifications. For example, FIG. 2 depicts a block diagram of a universal game server 210 configured to support game modifications, according to one or more aspects described herein. In various implementations, game server 210 may include a communicator 215, server-side assets 220, a simulation node 230, a player proxy node 240a, a non-player character (NPC) artificial intelligence (AI) node 240b, a game logic node 240c, a serializer 250, and/or other suitable game server related components described herein.

In various implementations, communicator 215 may be responsible for over-the-network communication. For example, communicator 215 may be configured to use protocols including UDP, TCP, IPX/SPX, and/or similar techniques to facilitate over-the-network communication. In some embodiments, communicator 215 may be configured to facilitate communication using one or more techniques described in U.S. patent application Ser. No. 18/669,729, entitled “SYSTEMS AND METHODS FOR TICK-LESS UDP GAME TRAFFIC,” filed May 21, 2024, the content of which is hereby incorporated by reference herein in its entirety.

In various implementations, server-side assets 220 may represent game-related information, descriptions, or data that makes the games running on universal game server 210 more unique. For example, server-side assets 220 may include third-party code (which may be processed by sandboxes of various nodes as described further herein), general game information (such as character types or races and their corresponding attributes, types of terrain, game-wide maps, user interface (UI) structure, and/or other game information), level descriptions, and/or other relevant information. Depending on coordinate system, level descriptions may include three-dimensional meshes of levels (often “decimated” to become extremely low-poly and without textures), graphs of two-dimensional polygons (“navmeshes”), and/or other level descriptions. In some implementations, level descriptions may include graphs of potential movements by objects within the game world, where objects are configured to move along edges of the graph. In some implementations, level descriptions may include coordinates of initial (or static) object locations within meshes, and/or references to third-party code that should be executed when a pre-defined event happens. In some implementations, server-side assets 220 may include descriptions of objects such as non-player characters (NPC)s, in-game items, and/or other objects to be used by either generic simulation/artificial intelligence (AI) logic or by third-party code. In various implementations, universal game server 210 may download server-side assets 220 from an intranet, such as, for example, from internal web servers hosting the server-side assets 220.

In various implementations, each of the simulation node 230, player proxy node 240a, NPC AI node 240b, and game logic node 240c may comprise a self-contained entity. For example, each of nodes may have its own non-shared state and processing messages (which may be referred to as “Actors” or “Reactors”). In some implementations, the individual nodes may comprise nodes such as in Node.js or nodes such as in Node.cpp. Other implementation of nodes may be based on technologies such as Win32 messages, or libraries such as libevent or libev. In some implementations, different nodes may run on the same thread of execution. In other implementations, different nodes may be run on different threads to allow for scalability. In other implementations, there may be multiple threads, each thread running one or more nodes.

In various implementations, simulation node 230 may be responsible for simulation of game world according to common (and often physical) rules. In various implementations, simulation node 230 may include a simulator 232. Simulator 232 may be configured to take input from players or users (as “adjusted player input”), from NPC AI nodes 240b (as “NPC input”), and as a result of time passing (e.g., timer events). In response to the input received, simulator 232 may be configured to modify a simulator state and a published state.

In various implementations, simulator 232 may be configured to use one or more techniques to represent a three-dimensional (3D) game state (i.e., internally and/or when publishing as published state). In some implementations, simulator 232 may be configured to use 3D coordinates. In some such implementations, simulator 232 may be configured to use simulation 3D coordinates corresponding to rendered 3D coordinates. In other implementations, simulator 232 may be configured to use transformed 3D coordinates, for example, using affine transformation and/or transformation by a 4×4 transformation matrix. In either case, to optimize published state, simulator 232 may still be configured to use any of the techniques or methods described in U.S. patent application Ser. No. 18/669,729.

In various implementations, simulator 232 may be configured to support one or more physics simulation techniques, including, for example, collision detection, 3D rigid body physics, constraint solving, ragdoll physics (e.g., using engines such as Havoc, Bullet, NVIDIA PhysX, and/or Blast), fluid dynamics (such as described in “Real-Time Fluid Dynamics for Games” by Jos Stam, published May 5, 2023, and available at http://graphics.cs.cmu.edu/nsp/course/15-464/Spring11/papers/StamFluidforGames.pdf (last visited May 13, 2024, the content of which is hereby incorporated by reference in its entirety and is also available in the NVIDIA FleX library), and/or destruction simulation (such as provided by NVIDIA Blast). In other implementations, integrating soft body physics and/or cloth libraries (e.g., by Havoc, NVIDIA PhysX, and NvCloth), and combustible fluid physics may also be used. In some implementations, any type of physics simulator mentioned above may be used to do one or more of the following: (a) make decisions affecting gameplay and/or (b) publish “partial simulation results” to simplify calculations of purely visual effects which have to be rendered by client computing system 110. In the case of “partial simulation results,” the server-side (i.e., game server 210) may be configured to publish only a part of the information necessary to render the scene. For example, when an explosion happens, many things may be simulated, such as, for example, particle simulation. In some implementations, the server-side may publish only coordinates (centers) of a few explosion balls, and size and starting velocities of any flying parts, leaving simulation of the remaining visual effects—such as dynamics of the balls and further parabolical movement of the flying parts—to the client-side (i.e., client computing system 110). In another example implementation, when simulating a ragdoll movement, simulator 232 may simulate and publish trajectory for only a center of mass of the ragdoll, but leave the simulation of limb movement to client computing system 110.

In some implementations, simulator 232 may be configured to use two-dimensional (2D)-based coordinates defined over a 2D polygon (or over a graph of 2D polygons, which may be referred to herein as a “navmesh”). In some such implementations, coordinates may be represented and/or published as a tuple comprising a number of a polygon, an X-position within the polygon, and a Y-position within the polygon. To describe this graph in 3D space, there may be 2D polygons on which objects (e.g., characters and/or vehicles) may move. Different polygons may represent areas with different properties, such as a different angle (e.g., one polygon may represent floor, while another polygon may represent a ladder), different movement speeds, and/or other properties.

To use 2D-based coordinates to represent a 3D game state, simulator 232 may be configured to prepare a graph from these 2D polygons. Each polygon may correspond to a “graph vertex.” Edges of the 2D polygons may be common in a 3D world and correspond to places where an object may cross from one polygon to another one. These edges may be used to “connect” the polygons within the graph, creating a “graph edge” between respective graph vertices. Then, a correspondence may be defined between coordinates in the 3D world and 2D-based coordinate tuples. In some implementations, simulator 232 may be configured to use such 2D navmesh coordinates for simulation and for publishing game state. In some implementations, simulator 232 may be configured to use 3D coordinates for simulation, and convert them into 2D-based coordinates for publishing using the aforementioned correspondence. If 2D-based navmesh coordinates are published, the aforementioned correspondence between coordinates in the 3D world and 2D-based coordinate tuples may be passed to client computer system 110 (e.g., as a part of client-side assets), such that client computer system 110 may use the correspondence to reconstruct 3D coordinates from 2D-based coordinates that it receives via subscription to the published state. In some implementations, simulator 232 may be configured to add an additional height coordinate to the 2D navmesh coordinates. For example, an additional height coordinate may be added such that the 2D-based coordinate tuple comprises “(number of polygon, X-position within polygon, Y-position within polygon, height-over-polygon),” where height-over-polygon may represent “height over corresponding 2D polygon” in 3D space.

In some implementations, simulator 232 may be configured to use graphs representing possible movements of characters (or objects), with possible positions of the objects being alongside the graph edges. In such implementations, coordinates may be represented and/or published as a tuple (number of graph edge, linear position within the edge). Such graph edges may correspond to line segments in the 3D world. In such implementations, simulator 232 may be configured to define a correspondence between line segments and 3D coordinates. In some implementations, simulator 232 may be configured to use such one-dimensional (1D)-based coordinates for simulation and use them for publishing in published state. In other implementations, simulator 232 may be configured to use 3D coordinates for simulation and convert them into 1D-based coordinates for publishing. If ID-based “graph” coordinates are published, correspondence between line segments and 3D coordinates may be passed to the client computer system 110 (e.g., as a part of client-side assets), such that client computer system 110 may use the correspondence to reconstruct 3D coordinates from 1D-based coordinates that it receives via subscription to the published state.

For any coordinate system used herein, simulator 232 may also be configured to implement a pathfinding algorithm. For example, simulator 232 may be configured to use any graph-based pathfinding algorithm, including A* pathfinding algorithm and its variations including Dijkstra Search, and Breadth-First. When implementing pathfinding in 2D/3D environments, a graph made of points of interest (POI) may be used as an input to graph-based pathfinding (i.e., POI may include current and target points, as well as vertices of the polygons involved) and other methods described, for example, in “Pathfinding in Two-Dimensional Worlds” by Anders Strand-Holm Vinther and Magnus Strand-Holm Vinther, published in 2015, and available at https://cs.au.dk/˜gerth/advising/thesis/anders-strand-holm-vinther_magnus-strand-holm-vinther.pdf (last visited May 13, 2024), the content of which is hereby incorporated by reference herein in its entirety. When using a cost-based pathfinding algorithm, simulation may define “cost” as “distance” or as “time.” In some implementations, simulator 232 may be configured to use one or more techniques or methods described in U.S. patent application Ser. No. 18/657,013, entitled “SYSTEMS AND METHODS FOR POLYGON-BASED PATHFINDING WITH DIFFERENT MOVEMENT SPEEDS,” filed May 7, 2024, the content of which is hereby incorporated by reference herein in its entirety.

In various implementations, each of player proxy node 240a, non-player character (NPC) artificial intelligence (AI) node 240b, and game logic node 240c may comprise a sandbox 242 (i.e., sandboxes 242a, 242b, and 242c, respectively) responsible for running third-party code within universal game server 210. In computer security, a sandbox is a security mechanism for separating running programs. This may be helpful in mitigating system failures and/or preventing software vulnerabilities from spreading. For example, a sandbox may be used to safely execute malicious code to avoid harming a host device, network, and/or other connected devices. In some implementations, a sandbox 242 may use techniques such as “chroot jail.” Chroot (short for “change root”) jail may be used to create a limited sandbox for a process to run in, such that a process cannot maliciously change data outside a prescribed directory tree. In other implementations, sandbox 242 may place binary third-party executables within virtual machines (VMs) and/or containers. For example, sandbox 242 may place binary third-party executables within virtual machines (VMs) including Hyper-V, VMWare, and LXC, or as a specialized “container runtime” such as Docker containers, CRI-O, and/or Windows Containers.

In some implementations, each sandbox 242 may be implemented using an engine (such as an interpreter or Just-in-time (or JIT) compiler) capable of running a programming language or bytecode. For example, a sandbox 242 may be implemented as a Javascript engine (e.g., V8/Node.js) running Javascript code, a Python engine (e.g., CPython) running Python code, a Lua engine (e.g., Lua or LuaJIT) running Lua code, and/or Webassembly (Wasm) engine (e.g. any of Wasm3 interpreter, Wasmer, Wasmtime, or V8/Node.js engines) running Wasm bytecode (i.e., pre-compiled from any supported programming languages including C/C++ or AssemblyScript).

In various implementations, each sandbox 242 may be configured to restrict access of third-party code 244 to system calls, such as socket calls or file calls. If a virtual machine approach is used, this may be done by using a container-provided or container-supported approach of restricting system application programming interfaces (or APIs) (such as Seccomp for Docker containers). If an interpreter/JIT approach is used, this may be done by limiting the list of APIs that are available for calls from within container. This is slightly different from VMs/containers in which failures are returned to already-existing API calls, as the interpreter/JIT approach may be able to avoid providing respective APIs entirely. In this regard, using an engine where all the external APIs available to third-party code 244 have to be explicitly declared is a plus. Examples of such engines include most WebAssembly (or Wasm) engines (such as Wasm3, Wasmer, Wasmtime, or v8), so long as the WebAssembly System Interface (or WASI) is disabled.

In various implementations, one or more instances of interpreter/JIT may be used within a VM/container to provide double protection. In some implementations, the virtual machine (or VM/Container) may include an intrusion detector to detect unusual activity within the VM/container, and take corrective action by terminating the virtual machine. For example, unusual activity may be excessive usage of one or more system resources that may prevented by resource quotas (e.g., CPU and/or memory quotas) and/or measured by VM/container. Another example of unusual activity may be unexpected system calls for a particular container. In either case, container-level techniques (such as container-supported Seccomp) or OS-level techniques (such as Seccomp directly or SE Linux) may be used. In various implementations, corrective action may range from reporting the incident to a support team to terminating the offending container.

In some cases, the only external APIs to be used by third-party code 244 may be (a) APIs sending/receiving messages to/from clients or other nodes, (b) APIs to interact with the external third-party state as described further herein, and (c) APIs to access server-side assets 220 (i.e., which may be read-only access).

In some implementations, each sandbox 242 may be configured to impose a resource quota, such as CPU and/or memory quotas, on the running third-party code 244. For example, in some implementations, VM/container-provided technologies may be used such as Docker (or LXC) Control Groups. In other implementations, interpreter/JIT-provided technologies may be used, such as instruction count in interpreter engine to limit CPU usage and/or limit on total amount of allocations. In yet other implementations, techniques external to interpreter/JIT but provided by sandbox 242 may be used, such as CPU instruction count metering and/or amount of memory provided to interpreter/JIT memory allocation calls. Common resources to be monitored and/or limited may include CPU cycles, amount of RAM used, and number/byte-size of messages sent/received per a pre-defined time, such as per-second or per-minute.

In some implementations, there may be different (and potentially independent) third-party code 244 within the same sandbox 242. In some implementations, third-party code 244 may be restricted to a state machine (or an event-driven program or reactor). In other words, third-party code 244 may only receive events and react to the events (e.g., by sandbox 242 calling third-party-code-provided event handlers). In such implementations, sandbox 242 may be configured to provide elaborated event triggers, including, for example, “NPC X sees PC”, “door is opened”, and/or “somebody crosses a specific line.” In some implementations, third-party code 244 may be configured to request the event triggers third-party code 244 itself needs. In some implementations, an API may be provided such that sandbox 242 may “subscribe to” (and optionally “unsubscribe from”) desired events. In other implementations, triggers (e.g., “when PC sees a specific NPC” trigger) may need to run on each simulation “tick.”

With such event triggers being highly specific, events for each piece of third-party code 244 may be triggered rarely. This, in turn, may mean that we may have a need for fast switching between different short-living event handlers (with only one event handler running at any given moment in time, and sandbox 242 running a different piece of third-party code 244 (e.g., each having a different external state) after previous third-party event handler completes) and/or to limit memory usage by third-party code 244. In some implementations, to reduce amount of memory used, sandbox 242 may be configured to serialize a state of the third-party code after the handler is called. In other implementations, sandbox 242 may be configured to deserialize it before the next handler is called. As such, sandbox 242 may be configured to re-use resources of corresponding VM/container or interpreter/JIT to run a next handler that belongs to different third-party code 244.

In some implementations, sandbox 242c of game logic node 240c may include external third-party state to ensure that third-party code is “stateless” (i.e., does not store meaningful data between event handlers except for an external state). Access to the external state may be provided by a set of APIs which allow manipulation of the external state. In some implementations, external third-party state may be a generic structure (such as JSON-like structure) and may be manipulated by generic APIs. If third-party code 244 is “stateless”, a sandbox 242 may not need to serialize/deserialize its state, improving performance of universal game server 210.

In some implementations, in particular when third-party code is “stateless,” an external third-party state may be used to transfer the current state of the system to another thread, or to another process, or even to another computer or datacenter. As long as the third-party code is “stateless,” the external third-party state is the only state which describes the system, making such transfers possible by simply waiting for current event handler to finish, serialize the external third-party state, move serialized state to another thread/process/computer/datacenter, where deserializing the state and running the same “stateless” code using this external third-party state may occur. A similar technique may be used to save/restore (and/or backup/restore) a system state by serializing/deserializing external third-party state. In some implementations, the external third-party state may be used to implement redundancy mechanisms for sandboxes. For example, there may be a “nodeA” storing a serialized external state of simulation “nodeB,” and recording all the input messages coming to the simulation nodeB. NodeA and nodeB may run in different VMs or on different computers or even in different datacenters. Then, in case of catastrophic failure of the nodeB, its state may be restored by deserializing the external third-party state stored on nodeA and replaying all the input messages on new instance of nodeB. And in the event of catastrophic failure of nodeA, it can be restored by serializing external third-party state from nodeB, and starting to record all the nodeB inputs on the new instance of nodeA. It should be noted that similar techniques may also be used without external third-party state, but then a serialized system state would need to include data about memory (and if applicable, a disk) of the whole VM/container/engine, which may be very resource-consuming compared to storing only the external third-party state. In addition, serializing structured externalized state may enable it to be stored in databases (such as RDBMS or NoSQL) in a structured manner, which may further enable the data analysis on the structured externalized state.

In various implementations, player proxy node 240a may be configured to receive player input from communicator 215. In some implementations, player proxy node 240a may comprise a node that “subscribes” to published state to perform one or more functions. In various implementations, player proxy node 240a (and/or player-supporting AI third-party code running within it), may be configured to augment player inputs, and generate/issue augmented player inputs based on the updated game state data (or subscription data). In some implementations, augmenting player inputs may include imitating character reflexes or conditioned reflexes by taking an evasive action based on a decision regarding whether a collision is imminent. In an example implementation, player proxy node 240a may be configured to “see” or determine (e.g., from subscription to a “published state”) that a collision is imminent (e.g., somebody else is going to run into PC), and then take evasive action. As another example, in some implementation player proxy node 240a may include simulating some reflexes and conditioned reflexes (e.g., alcoholic PC is trying to steal a bottle of spirit within his reach without player taking any action). In some implementations, augmenting player inputs may include adding visual information to augment reflexes within (or restricted to) player character's (PC) viewing frustum. For example, when calculating “collision is imminent” (or any other condition), player proxy node 240a may be configured to limit information available to Player Proxy AI, to PC's “viewing frustum.”

In some implementations, augmenting AI code may be a part of player proxy node 240a. In other implementations, augmenting AI code may be implemented by third-party code 244 running within respective sandbox 242a. In certain implementations, augmenting AI code may be performed by a combination of both. In some implementations, augmenting player inputs may be based on event trigger(s). In some implementations, an event trigger may be based on a tick that is skipped. In some implementations, the event trigger may be tick-less, as described herein.

In some implementations, player proxy node 240a may be configured to run PC-specific quests. For example, player proxy node 240a may be configured to run PC-specific quests such as “if PC walks through this door for n^{th} time, then rock falls on its head,” with the latter passed to simulation node 230 as an environment change input.

In various implementations, player proxy node 240a may be configured to try to address issues resulting from missing packets and/or packet delays between client computer system 110 and game server 210. In some implementations, player proxy node 240a may be configured to detect that client computer system 110 is disconnected, and take some corrective action. In some implementations, corrective action may include informing simulation node 230 that PC has disappeared. In some implementations, corrective action may include enabling a special “disconnect” AI, which may, for example, make PC to end its conversation and then to walk out of the room instead of disappearing in the thin air. In various implementations, player proxy node 240a may then be configured to try to average packet arrival times to reduce jitter issues when player inputs are sent to simulation node 230. In some implementations, player proxy node 240a may be configured to feed time of incoming packet arrival into a Phase-Locked Loop (PLL) or Delay-Locked Loop (DLL). Then, packets may be sent to simulation node 230 on a certain phase of PLL/DLL output signal (i.e., “clock recovery” with PLL/DLL).

In various implementations, NPC AI node 240b may comprise a node that “subscribes” to published state to perform one or more functions, including simulating NPCs in an online game and transferring decisions regarding NPCs taking certain actions as NPC input. In some implementations, NPC AI code may be a part of the NPC AI node itself. In other implementations, NPC AI code may be NPC AI code implemented by third-party code 244 running within respective sandbox 242b. In certain implementations, NPC AI code may be a combination of both. In some implementations, NPC AI logic may include some or all of the same “augmenting” logic described with respect to player proxy node 240a.

In various implementations, game logic node 240c may comprise a node that “subscribes” to published state and runs certain logic specific to the game currently run on universal game server 210. For example, game logic node 240c may be configured to run non-PC-related quests, such as, for example, game-wide or location-specific quests.

In various implementations, serializer 250 may comprise an entity responsible for gathering current game states including, but not limited to, state of player proxy nodes 240a, state of NPC AI nodes 240b, state of game logic nodes 240c, and state of simulation node(s) 230. In some implementations, serializer 250 may store current game states to persistent storage 260 (e.g., database, file, etc.), and restore the current game states from persistent storage 260.

In various implementations, universal game server 210 may comprise an authoritative game server. An “authoritative” game server is a game server in which all the decisions affecting other players are made at the game server. This may be beneficial to address cheating as explained, for example, in “Fast-Paced Multiplayer (Part I): Client-Server Game Architecture” by Gabriel Gambetta, available at https://www.gabrielgambetta.com/client-server-game-architecture.html (last visited May 14, 2024).

In various implementations, universal game server 210 may be used by a game publisher to provide a “base” game and allow for “modders” (or users) to write “mods” (or otherwise make modifications) to the game. Notably, it is typical for the traditional “mods” to be written for the client-side (i.e., at the client-computer system 110), but not so for “mods” running on the server-side (e.g., at game server 210). Moreover, running third-party code on servers is known to be problematic because of both security and resource consumption issues. In contrast, the solution embodied in the present disclosure addresses these problems. In various implementations, in order to facilitate (or support) “mods” on the server-side, game server 210 may be configured to provide a “base” version of a game. In various implementations, the base version of a game may be represented by a base set of server-side assets 220. For example, the base set of server-side assets 220 may include graphics assets (e.g., such as meshes and textures) and code, which may be considered by universal game server 210 as third-party code 244. In various implementations, game server 210 may allow modders to “override” certain parts of server-side assets 220 with their own versions. As used herein, “overriding” may include replacing existing parts, expanding them, and/or otherwise making modifications to one or more server-side assets 220. In some implementations, “overriding” may involve overriding third-party code 244. Then, universal game server 210 may be configured to run a “modder” (or modified) version of the game using modders “overridden” code as third-party code 244. In various implementations, third-party code 244 may be run within a sandbox 242 and may be prevented from making potentially-malicious system calls and/or may have its usage of resources monitored and/or restricted.

Improvements described herein may improve performance of universal game server 210; in particular, performance may benefit from reduced context switches and/or from 2D-/1D-based simulation, as described herein. In some cases, 2D-/1D-based simulation may also help to reduce RAM usage. In various implementations, universal game server 210 may be configured to support more players using the same resources, resulting in lower costs (e.g., lower cloud service costs in virtualized cloud or bare-metal cloud) for funning such universal game server(s) 210.

In some implementations, universal game server 210 may be configured to use another type of sandbox 242 within simulation node 230, as opposed to the sandboxes 242 described herein. For example, this sandbox 242 may be used to run game-specific physics simulations as opposed to generic physics simulations.

In various implementations, simulation node 230 may be responsible for simulation of game world according to common (often physical) rules. In various implementations, simulation is tick-based. Put differently, simulation may happen each and every “simulation tick,” with “simulation ticks” happening at regular intervals. For example, simulations may occur at 20 simulation ticks per second. In such implementations, simulation node 230 may be configured to issue a “time event” request at every 1/20 of a second (i.e., every 50 milliseconds). In some implementations, simulation node 230 may be configured to “skip” certain simulation ticks. Here, “skipping” simulation ticks may be different from “skipping” publication updates as described in U.S. patent application Ser. No. 18/669,729, which may include running a simulation at a simulation tick, but after determining that the data is the same, skipping the update. To the contrary, here, “skipping” simulation ticks comprises not running a simulation at a simulation tick at all. Simulation node 230 skipping simulation ticks may improve performance of universal game server 210.

In order to skip a simulation at a simulation tick, simulation node 230 (or simulator 232 of simulation node 230) may be configured to determine that, unless input is received, all the simulation can be predicted by client computer system 110 based on the already-published information. For example, using predictive coding and/or other techniques described in U.S. patent application Ser. No. 18/669,729, client computer system 110 may be configured to use published object information (such as coordinates, a velocity, and a moment TObj at which the coordinates and velocity apply) to calculate coordinates and velocities for subsequent moments t>=TObj. In an example implementation, simulation node 230 may be configured to determine that a simulation tick may be skipped if published coordinates and velocities as of moment TObj may be used by simulator 232 to calculate potential collisions between pairs of objects, thus allowing simulation node 230 to skip all the ticks until any two objects may collide. In such implementations, if there is an incoming event (such as adjusted player input or NPC input), simulation node 230 may be configured to process it even if it was going to “skip” a respective tick. Also, calculations of the collisions may have to be re-done after an incoming event. In some implementations, if client-side includes physics simulation (e.g., such as a rigid-body simulation), simulator 232 may be configured to decide to skip even those ticks which corresponds to collisions as long as outcomes of collisions are predictable by physics simulation at the client-side (i.e., at client computer system 110). For example, if client-side simulation is configured to simulate collisions with static objects (e.g., walls) but not collisions between moving objects, simulator 232 may be configured to skip ticks corresponding to collisions with static objects (e.g., walls), but not the ticks corresponding to the collisions between moving objects.

In some implementations, simulator 232 may be configured to run a “pre-simulation,” which may include (a) running simulation in advance (i.e., given current data, determining what will happen on next tick, then on a second-next tick, and so on), (b) compare publication results on simulation ticks in advance, and (c) skip ticks as long as publication results stay the same. Note that even if the number of calculations performed by simulator 232 is more than the number of calculations without skipping, in some implementations, it may still be beneficial from a performance perspective due to a reduced number of inter-thread context switches (discussed further herein).

In various implementations, for simulation ticks that are skipped, simulation node 230 may be configured to avoid being “woken-up” at all. Again, this may improve server-side performance due to a reduced number of inter-thread context switches. While total amount of calculations in this case may be even higher than with per-tick simulation (due to intervening input events which may cause re-calculations), this may still provide overall performance gain due to fewer thread context switches, and as a result, better temporal locality (which leads to decreased cache invalidation). Here, being “woken-up” may mean performing any kind of operation on simulation node 230, which in turn often causes expensive operations such as inter-thread context switches, loading data from simulation node 230 into CPU caches, and/or other operations. For example, after determining that some simulation ticks may be skipped, simulation node 230 may be configured to issue a “time event” request which is timed not at a usual “in 1/20 of the second”, but adding 1/20 second for each tick-to-be-skipped. This will allow simulation node 230 to avoid being “woken-up” for the number of skipped ticks.

In some implementations, including when most of the potential collisions and inter-object interactions may be predicted correctly, simulation node 230 may be configured to make the system completely tick-less. For example, simulation node 230 may be configured to issue a “time event” request to arrive at the moment of potential collision or inter-object interaction.

In some implementations, “tick-based” and/or “skipping ticks,” and/or “tick-less” techniques may be used to implement one or more of the event triggers (such as “when NPC can see PC” trigger). For example, “tick-based” event trigger detection may involve updating a state on each “tick,” and determining whether a trigger condition is satisfied in a new environment. In other implementations, and similar to “skipped ticks” for simulation, simulation node 230 may determine that some “ticks” may be skipped by determining that a trigger condition cannot be satisfied for some upcoming “ticks” based on current data and calculated information based on predictive coding. In other implementations, and in a manner similar to “tick-less” simulation, simulation node 230 may be configured to calculate an upcoming (or next) time when trigger condition is likely to be satisfied and issue an appropriate timer event at that time. In implementations in which multiple triggers exist per node, ticks may be fully “skipped” (by increasing a time interval of timer events) only if calculations for all the triggers show that the conditions cannot be satisfied. In a similar manner, for “tick-less” trigger detection, the time for the next timer event may be a minimum of times calculated for individual “tick-less” triggers.

In various implementations, a physics simulation (e.g., such as a rigid-body simulation) or some AI (such as inter-NPC collision avoidance AI) may be used on the client side (i.e., at client computer system 110) to predict some or all potential collisions and/or inter-object interactions on the client-side, as described for example in U.S. patent application Ser. No. 18/669,729. In such implementations, a greater number of ticks may be skipped on the server-side (as the client-side may be able to work longer without any additional inputs, just the same way as server-side). In similar situations in tick-less systems, intervals of “timer events” may be lengthened to improve performance.

In some implementations, a game client (i.e., at client computer system 110) may send timestamps (generated on the client-side) with some or all player inputs provided to universal game server 210. For example, client computer system 110 may be configured to send client-side timestamps to implement lag compensation and/or server rewind, as described for example in “Development and Deployment of Multiplayer Online Games, Vol. I: GDD, Authoritative Servers, Communications (Development and Deployment of Multiplayer Games)” by “No Bugs” Hare, translated by Sergey Ignatchenko, and published Jul. 1, 2017, and/or in “Fast-Paced Multiplayer (Part IV): Lag Compensation” by Gabriel Gambetta, available at https://www.gabrielgambetta.com/lag-compensation.html (last visited May 14, 2024), the content of each of which is hereby incorporated by reference herein in their entirety.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination. In various implementations, electronic storage may include persistent storage 260.

Electronic storage 130 may store software algorithms, information determined by processor(s) 112, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

In various implementations, game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and an asset received in response to a request. In various implementations, game server 210 may be configured as a server device (e.g., having one or more server blades, processors, etc.) and/or as another device capable of providing publications and game state data related to an online game to client computer system 110.

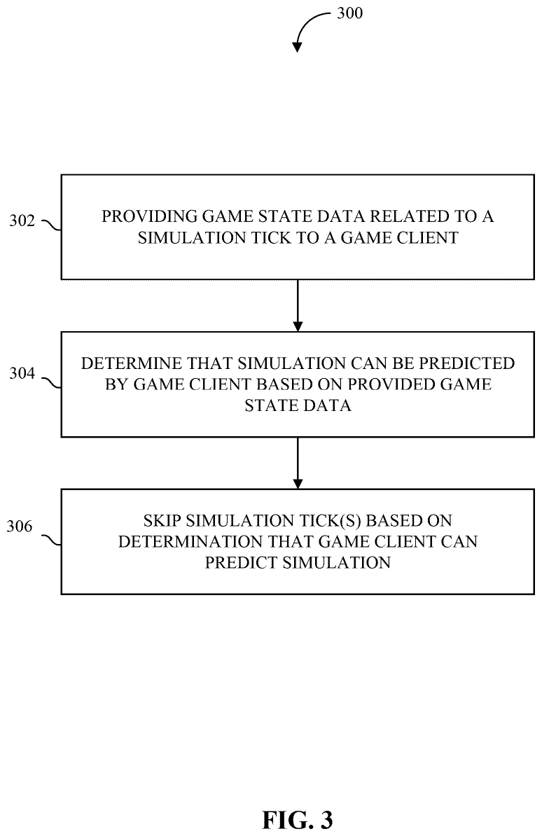

FIG. 3 illustrates an example of a process 300 for improving performance of server-side simulations by skipping simulation ticks, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components of game server 210 described in detail above.

In an operation 302, process 300 may include a game server providing to one or more client computer systems game state data related to a first time corresponding to a simulation tick. In various implementations, the game state data may include information necessary for client computer system to predict a simulation at subsequent points in time unless input is received.

In an operation 304, process 300 may include the game server determining that the simulation can be predicted by the one or more client computer systems at a point in time corresponding to at least one subsequent simulation tick based on the previously provided game state data related to the first time. In various implementations, determining that the simulation can be predicted by a client computer system may include running the simulation in advance for one or more subsequent points in time based on the game state data related to the first time and comparing publication results for the one or more subsequent points in time to the pre-simulation run based on the game state data related to the first time. In such implementations, simulation ticks may be skipped as long as publication results are the same as the pre-simulation run based on the game state data related to the first time.

In an operation 306, process 300 may include the game server skipping one or more simulation ticks responsive to a determination that the simulation can be predicted by the one or more client computer systems. In various implementations, simulations may not be run on game server for simulation ticks that are skipped. In various implementations, a duration may be determined with no inter-object interactions, wherein a number of skipped ticks is based on a time interval with no inter-object interactions. In various implementations, skipping the one or more simulation ticks may comprise increasing a time interval corresponding to a next timer event. In various implementations, the next timer event may correspond to a next time at which an update to a simulation is to occur.

In some implementations, process 300 may also include issuing an event to an event subscriber based on detection of an event trigger. In some implementations, an event trigger may be detected by checking whether an event condition is satisfied on each simulation tick. In some implementations, one or more simulation ticks may be skipped based further on a determination that calculations for multiple triggers show that conditions cannot be satisfied.

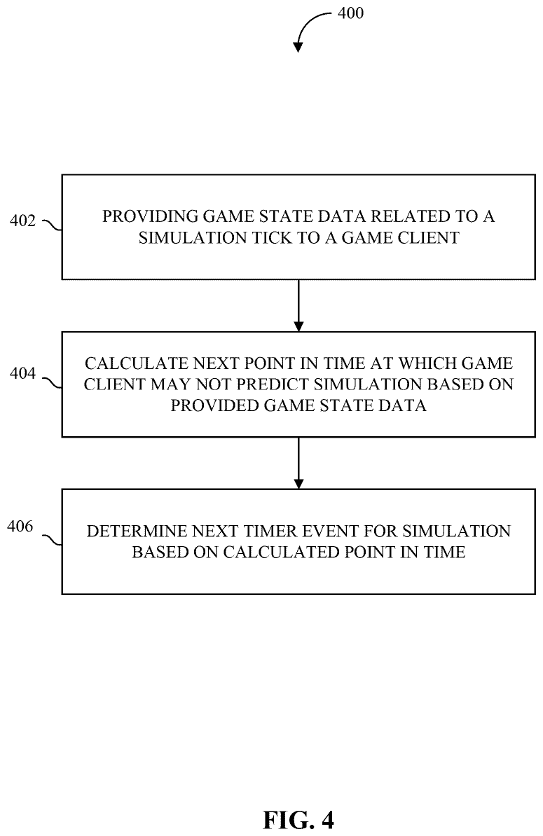

FIG. 4 illustrates an example of a process 400 for improving performance of server-side simulations by abolishing simulation ticks entirely, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components of game server 210 described in detail above.

In an operation 402, process 400 may include a game server providing to one or more client computer systems game state data related to a first time. In various implementations, the game state data may include information necessary for client computer system to predict a simulation at subsequent points in time unless input is received.

In an operation 404, process 400 may include the game server calculating a next point in time at which the one or more client computer systems may not predict a simulation based on the game state data related to the first time.

In an operation 406, process 400 may include the game server determining a next timer event for simulation based on the calculated point in time at which the one or more client computer systems may not predict a simulation based on the game state data related to the first time. In various implementations, the next timer event may correspond to a next time at which an update to a simulation is to occur. In some implementations, determining the next timer event may comprise calculating a duration of time with no interactions between objects. In some implementations, determining the next timer event may comprise calculating a duration of time with no unpredictable interactions between objects. For example, an unpredictable interaction between objects may comprise a collision between moving objects. In some implementations, determining the next timer event may comprise determining that calculations for a trigger shows that a condition cannot be satisfied. In some implementations, a node may contain multiple triggers. In such implementations, a next event trigger may be calculated by taking a minimum of the times for those individual triggers.

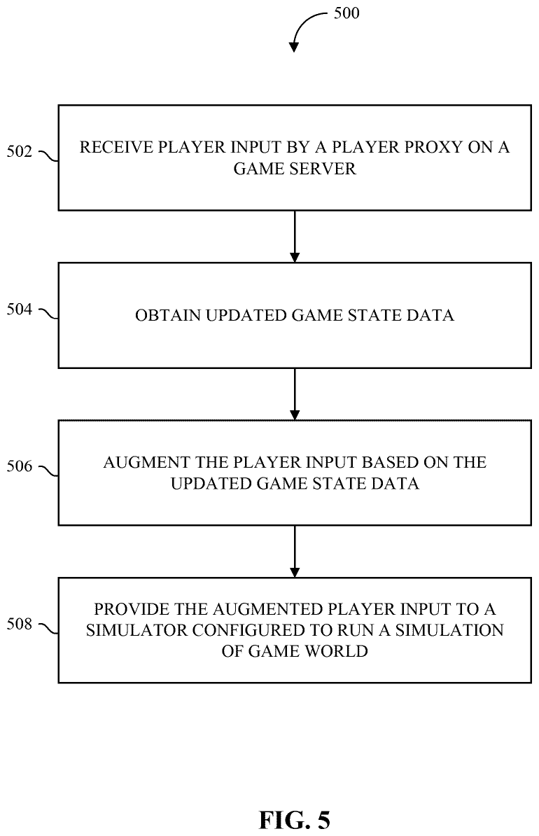

FIG. 5 illustrates an example of a process 500 for simulating character reflexes in online games, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components of game server 210 described in detail above.

In an operation 502, process 500 may include a player proxy on a game server receiving player input. In an operation 504, process 500 may include the player proxy obtaining updated game state data. In an operation 506, process 500 may include the player proxy augmenting the player input based on the updated game state data. In various implementations, augmenting the player input may comprise imitating character reflexes or conditioned reflexes. In some implementations, augmenting the player input may comprise taking an evasive action based on a decision regarding whether a collision is imminent. In some implementations, augmenting the player input may comprise adding visual information to augment reflexes. In some implementations, the visual information added to augment reflexes may be restricted to a player character's viewing frustum. In some implementations, the player input may be augmented based on the updated game state data in response to an event trigger. In an operation 508, process 500 may include the player proxy providing the augmented player input to a simulator configured to run a simulation of a game world based at least in part on the augmented player input. In some implementations, the operations of process of 500 may similarly be performed by an NPC AI node based, for example, on NPC input to augment said input for display on a non-player character.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 and/or component(s) of game server 210 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 and/or component(s) of game server 210 as well as data that may be manipulated by processor(s) 112 and/or component(s) of game server 210. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 and/or game server 210 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

1. A game server for providing updates related to an online game, wherein the game server is configured to sandbox potentially malicious event-driven code, the game server comprising:
a simulator configured to modify a simulator state and a published state based on input received or as a result of time passing; and
one or more nodes each comprising a sandbox responsible for running third-party code within the game server, wherein the third-party code is event-driven in that it may only receive and react to events, and wherein the third party-code may only manipulate an external state via an application programming interface (API).

2. The game server of claim 1, wherein a sandbox of a first node of the one or more nodes is configured to run at least two pieces of third-party code, wherein the sandbox of the first node is configured to run one of the at least two pieces of third-party code at a time with a next piece of code running after a previous piece of code is completed.

3. The game server of claim 2, wherein each of the at least two pieces of third-party code uses a different external state.

4. The game server of claim 1, wherein the third-party code is run by a programming language engine.

5. The game server of claim 4, wherein the programming language engine comprises a Web Assembly (Wasm) engine.

6. The game server of claim 4, wherein the programming language engine comprises an interpreter or Just-in-time (JIT) compiler of a programming language.

7. The game server of claim 6, wherein the interpreter or Just-in-time (JIT) compiler is run within a virtual machine or other container.

8. The game server of claim 7, wherein the virtual machine or other container includes an intrusion detector configured to detect unusual activity within the virtual machine or other container.

9. The game server of claim 8, wherein the intrusion detector is configured to take corrective action in response to detecting unusual activity within the virtual machine or other container, wherein the corrective action comprises terminating the virtual machine or other container.

10. The game server of claim 1, wherein the third-party code run on the game server includes base assets corresponding to a version of an online game provided by a publisher of the online game and one or more overridden assets that comprise base assets that have been modified by a user, wherein the game server runs a modified version of the online game when running using the one or more overridden assets.

11-48. (canceled)
